(19) United States
(12) Patent Application Publication
(10) Pub. No.: US 2017/0119512 A1
(43) Pub. Date: May 4, 2017

(54) TEETH WHITENING LIGHT

(71) Applicant: MK Products, Inc., Irvine, CA (US)

(72) Inventors: Christopher A. Westlake, Silverado, CA (US); Matthew A. Fiore, Rancho Santa Margarita, CA (US)

(21) Appl. No.: 14/930,181

(22) Filed: Nov. 2, 2015

(51) Int. Cl. A61C 19/06

(52) U.S. Cl. CPC A61C 19/066

(57) ABSTRACT

A teeth whiting device including a main housing having a main housing opening disposed about an axis offset from a vertical axis. The teeth whitening device further includes an extension arm having a first arm end portion and an opposed second arm end. The extension arm is coupled to the main housing adjacent the first arm end portion and extends through the main housing opening. A light emitting unit is coupled to the second arm end portion and is adapted to emit light within a prescribed wavelength range toward teeth of a user for whitening the teeth. The extension arm is flexible and capable of assuming a prescribed configuration to enable selective positioning of the light emitting unit relative to the main housing.

### CROSS-REFERENCE TO RELATED APPLICATIONS

Not applicable.

### STATEMENT RE: FEDERALLY SPONSORED RESEARCH/DEVELOPMENT

Not applicable

### BACKGROUND OF THE INVENTION

Technical Field of the Invention

The present invention relates generally to a device for whitening a user's teeth, and more particularly, to a teeth whitening device having a light emitting unit coupled to a selectively adjustable extension arm which receives support from a main housing when the extension arm extends in a generally horizontal direction.

Description of the Related Art

Teeth discoloration is an undesirable consequence, oftentimes associated with aging and consumption of staining substances. Along these lines, it is believed that as people age, the adult teeth often become darker due to changes in the mineral structure of the tooth as the enamel becomes less porous. Teeth may also become stained by bacterial pigments, food, and tobacco. Furthermore, certain medications, such as tetracycline, are also believed to cause teeth stains or create undesirable discoloration of one's teeth.

In view of the unwanted appearance associated teeth discoloration, several teeth whitening products and procedures have been developed. Along these lines, bleaching of teeth has become popular and is a widely used procedure which is useful in lightening the discolorations which have accumulated on a tooth surface over time. Power or light-accelerated bleaching is a common procedure which uses light energy to accelerate the process of bleaching for teeth whitening. Typical light-accelerated bleaching devices include a light source and a dental tray which holds a tooth whitening agent. The dental tray is pressed onto the user's teeth and the light source directs light toward the tray. The heat produced by the light source typically causes a chemical reaction within the whitening agent upon activation of the device. The whitening agent is allowed to bathe or coat the teeth and the chemical reaction enhances or accelerates the effect of the tooth whitening application.

A conventional light-accelerated bleaching device typically includes a stand that is adapted to be supported on an underlying flooring surface, wherein the stand includes an adjustable arm extending vertically therefrom. A light source is located at the end of the adjustable arm for emitting the light needed during the teeth whitening procedure. Prior to turning the light source on, the adjustable arm is flexed and bent to position the light source adjacent the patient's teeth. After the teeth whitening procedure, the adjustable arm is typically bent downwardly to stow the adjustable arm along the exterior surface of the support stand.

Although light accelerated bleaching has proven to be an effective means of reducing light discolorations, the above-described conventional light-accelerated bleaching devices suffer from several deficiencies. In general, conventional devices are typically bulky and prone to break after repeated use. One of the most common problems associated with conventional devices is that the extension arm breaks over time. In particular, repeated bending of the extension arm from its generally vertical extension out of the stand, to a generally horizontal position during use creates considerable stresses in the extension arm. Those stresses cause the extension arm to fatigue, which eventually results in the extension arm breaking.

Another problem associated with conventional devices is that they tend to be bulky and are prone to tipping. The support stand and extension arm are typically elongate devices, which may result in the device having a relatively high center of gravity, making the device susceptible to tipping.

In view of the foregoing, there is a need in the art for a device which addresses the deficiencies discussed above. In particular, there is a need for an improved light-accelerated bleaching device that is more robust than conventional devices.

### BRIEF SUMMARY OF THE INVENTION

The present invention specifically addresses and alleviates the above-identified deficiencies in the art. Various aspects of the teeth whitening device include an extension arm that extends from a main housing such that the extension arm is at least partially supported by the main housing when the extension arm extends in a generally horizontal configuration. The support provided to the extension arm reduces the stresses in the arm and thereby extends the life of the extension arm. Other aspects of the teeth whitening device are directed toward lowering the center of gravity of the device, thereby making the device less prone to tipping.

According to one embodiment, there is provided a teeth whiting device including a main housing having a main housing opening disposed about an axis offset from a vertical axis. The teeth whitening device further includes an extension arm having a first arm end portion and an opposed second arm end. The extension arm is coupled to the main housing adjacent the first arm end portion and extends through the main housing opening. A light emitting unit is coupled to the second arm end portion and is adapted to emit light within a prescribed wavelength range toward the teeth of a user for whitening the teeth. The extension arm is flexible and capable of assuming a prescribed configuration to enable selective positioning of the light emitting unit relative to the main housing.

The main housing may include a sidewall at least partially defining the main housing opening and adapted to provide support to the extension arm.

The teeth whitening device may include a base coupled to the main housing, wherein the base includes a peripheral section and a center section recessed relative to the peripheral section. The base may include a plurality of wheels mounted to peripheral section. The teeth whitening device may further include an elongate rod having a first rod end portion and an opposing second rod end. The first rod end portion may be coupled to the main housing and the second rod end portion may be connected to the center section of the base. The main housing is adapted to be snap engageable with the first rod end.

The light emitting unit may include a light emitting housing, a light, and a heat sink in thermodynamic communication with the light. The light and the heat sink may be disposed within the light emitting housing. A fan may be in fluid communication with the heat sink for creating a convective fluid flow over the heat sink. The fan may be located in the light emitting housing. The fan speed may be controlled by software to generate an airflow within the light emitting housing, such that the temperature within the light emitting housing is greater than ambient to promote gel activation. Preferably, the temperature within the light emitting housing is maintained within the range of 95-105 degrees Fahrenheit.

The teeth whitening may include a user interface coupled to the main housing. The user interface may include a touch screen display or a membrane display.

The present disclosure is best understood by reference to the following detailed description when read in conjunction with the accompanying drawings.

### BRIEF DESCRIPTION OF THE DRAWINGS

These as well as other features of the present disclosure will become more apparent upon reference to the drawings wherein:

FIG. 1 is a front upper perspective view of a teeth whitening device constructed in accordance with an embodiment of the disclosure;

FIG. 2 is a rear upper perspective view of the teeth whitening device depicted in FIG. 1;

FIG. 3 is an exploded upper perspective view of the teeth whitening device;

FIG. 4 is an exploded perspective view of a main housing detached from an elongate rod;

FIG. 5 is a partial cross sectional view of the main housing, an extension arm, and a light emitting unit which form part of the teeth whitening unit; and

FIG. 6 is a side view of a clamp selectively engageable with the extension arm for connecting the extension arm to a table, dental chair, or other support surface.

Common reference numerals are used throughout the drawings and detailed description to indicate like elements.

### DETAILED DESCRIPTION

The detailed description set forth below is intended as a description of the presently preferred embodiment of the disclosure, and is not intended to represent the only form in which the present disclosure may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the disclosure.

Referring now to the drawings, wherein the showings are for purposes of illustrating a preferred embodiment of the present invention only, and not for purposes of limiting the same, there is shown a teeth whitening device 10 constructed in accordance with an embodiment of the present invention. The teeth whitening device 10 is configured for use with a teeth whitening agent. e.g., a gel, wherein the device 10 emits light at a particular wavelength for accelerating the process of whitening a user's teeth. Light is emitted at a distal end of an extension arm 12 which is positioned in front of the patient's teeth during the whitening procedure. Various aspects of the present invention are specifically directed toward enhancing the flexibility and durability of the extension arm 12 relative to conventional teeth whitening devices. The enhanced durability is at least partially attributable to a unique connection between the extension arm 12 and a main housing 14, wherein the extension arm 12 extends outwardly from the main housing 14 at an angle offset from a vertical axis, which results in the main housing 14 providing vertical support the extension arm.

According to one embodiment, the extension arm 12 is elongate and interconnects the main housing 14 with a light emitting unit 16. The extension arm 12 is specifically configured and adapted to enable selective adjustment and positioning of the extension arm 12 for enhancing the positional adaptability of the teeth whitening device 10, and more specifically, for positioning the light emitting unit 16 adjacent the user's teeth. In other words the extension arm 12 may be bent or otherwise manually manipulated into a particular shape or configuration and have sufficient internal support to maintain the desired position.

The main housing 14 is connected to a first arm end portion 18 and the light emitting unit 16 is connected to a second arm end portion 20. The main housing 14 houses components for controlling operation of the teeth whitening device 10, as will be described in more detail below. One embodiment of the main housing 14 includes a head portion 22 and a neck portion 24, wherein the head portion 22 houses the aforementioned control components as well as a user interface 26. The neck portion 24 is generally tubular, and thus includes a hollow internal cavity. The neck portion 24 depicted in the figures is generally circular, although it is understood that the neck portion 24 may be other shapes, such as hexagonal, quadrangular, etc., without departing from the spirit and scope of the present invention. One or more flanges 28 may extend radially outward from the neck portion 24, wherein each flange 28 includes an opening formed therein for conveniently storing protective glasses/eyewear (not shown) when not used by the user.

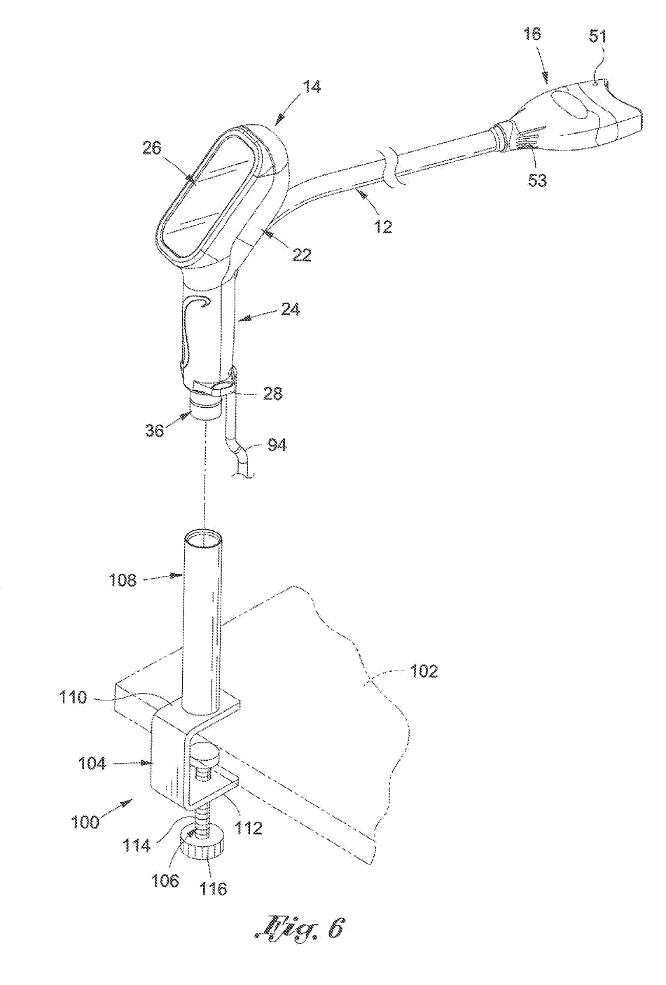

One aspect of the present invention is directed toward the unique connection between the extension arm 12 and the main housing 14. Along these lines, the main housing 14 includes a main housing opening 30 (see FIG. 5) that is offset from a vertical axis. In particular, the main housing opening 30 is disposed about an axis that is offset or angled from a vertical axis. According to one embodiment, the main housing opening 30 extends through a side portion of the main housing 14. As shown in FIG. 5, the main housing opening 30 is at least partially defined by the neck portion 24 as well as the head portion 22. The neck portion 24 may include a neck engagement region 25 and the head portion 22 may include head engagement region 27 which engage with respective regions of the extension arm 12 to provide support the extension arm 12. As can be seen in FIG. 5, the engagement regions 25, 27 extend axially along an external surface of the extension arm 12. The extension arm 12 is coupled to the main housing 14 such that the extension arm 12 extends through the main housing opening 30. The offset configuration of the main housing opening 30 results in the extension arm 12 extending out of the main housing 14 at an angle that is also offset from a vertical axis.

It is understood that prior art teeth whitening devices may employ an extension arm that extends from the top of a housing in a substantially vertical direction. Consequently, many prior art extension arms extend from an opening in the housing that is disposed about a substantially vertical axis. Therefore, when the prior art extension arm is bent from its generally vertical position so as to extend in a generally horizontal position, as is customary during a teeth whitening procedure, considerable stresses are imparted on the extension arm. In this respect, the prior art housing provides little, if any, vertical support to the extension arm when the extension arm is placed in a generally horizontal position, which results in the considerable stresses imparted on the arm. Over time, the stress in the extension arm would cause the extension arm to break.

One aspect of the present invention is directed toward providing additional support to the extension arm 12 when the extension arm 12 extends in a generally horizontal direction. This is achieved by forming the main housing opening 30 about an axis that is offset from the vertical axis, such that when the extension arm 12 extends out of the main housing opening 30, the extension arm 12 does not extend substantially vertically, but rather, extends at an angle offset from the vertical axis. This results in the main housing 14 bearing some of the load created when the extension arm 12 is in the generally horizontal position. Along these lines, the portion of the housing 14 located below the extension arm 12 will be disposed in compression as the extension arm 12 transitions toward a generally horizontal position.

The first arm end portion 18 extends within the main housing 14 and is secured therein. In the embodiment depicted in FIG. 5, the extension arm 12 is restrained by an internal flange 32 having an opening formed therein to accommodate the extension arm 12. A plug 34 is coupled to the end of the extension arm 12 and is adapted to effectuate engagement between the extension arm 12 and a connector 36. In this respect, the extension arm 12 is adapted to remain engaged with the main housing 14.

The light emitting unit 16 is coupled to the second arm end portion 20 and includes a light emitting housing 38 (see FIG. 5) defining an interior compartment 40. The housing 38 may be divided into a non-transparent section 42 and a transparent section 44 which is adapted to allow light to pass therethrough. The transparent section 44 may include an arcuate wall 46, which generally conforms to the curvature of a patient's teeth. A light device 48, such as one or more light emitting diodes (LED), is/are disposed within the interior compartment 40 along with a heat sink 50, which is in thermodynamic communication with the light device 48. The light device 48 is adapted to emit light at a prescribed frequency for whitening teeth. According to one embodiment, the light device 48 is configured to emit light within a spectral range of 465-485 nm, although it is understood that in other embodiments, the light may be emitted at wavelengths less than 465 nm or greater than 485 nm.

During operation of the light device 48, heat is generated, which is transferred to the heat sink 50. According to one embodiment, the teeth whitening device 10 includes a fan 52 for blowing air over the heat sink 50 to maintain the operating temperature within an acceptable operative range. Along these lines, the light emitting housing 38 may include one or more air inlets 51 to allow ambient air to be drawn into the light emitting housing 38 from the fan 52, as well as one or more air outlets 53 to allow air to be exhausted out of the light emitting housing 38 and into the ambient environment. The LEDs 48 may generate sufficient heat to activate the whitening gel disposed on the patient's teeth. Indeed, the heat generated by the LEDs may become too high for the comfort of the patient, and as such, the fan 52 may be operative to generate an air flow to cool the temperature within the light emitting housing 38 and maintain the temperature within a preferred operating range, which may be 95-105 degrees Fahrenheit or approximately 20 degrees Fahrenheit above the ambient temperature. Of course, in other embodiments, the acceptable operating temperature may be below 95° F. or above 105° F. without departing from the spirit and scope of the present invention.

In one embodiment, the fan 52 is adapted to generate an air flow which exhausts air from the light emitting housing 38 and away from the patient, i.e., hot air is not blow towards the user's face. As cooler ambient air is drawn in through the inlet(s) 51, the air flows over the heat sink 50 such that heat is transferred from the heat sink 50 to the passing air. The speed of the fan 52 may be controlled by software and may be dependent upon the temperature within the light emitting housing 38, e.g., a higher temperature will require a higher fan speed, and a lower temperature may require a lower fan speed. It is also understood that the fan speed 52 may also be dependent on the temperature of the ambient air. In particular, if the ambient air temperature is low, the temperature within the light emitting housing 38 can be cooled quicker than a higher ambient air temperature. In this respect, the fan 52 may operate at a slower speed relative to conventional teeth whitening units so as to maintain the temperature of the air flow within a prescribed temperature range. In order to maintain the temperature within the desired temperature range, the fan 52 may be in operative communication with a temperature sensor which measures the temperature of the air flow. The speed of the fan 52 may be adjusted as needed. i.e., increased or decreased, to bring the temperature within the desired range.

According to one embodiment, the main housing 14 is elevated above the ground by virtue of an elongate support rod 56 and a base 58. The elongate rod 56 includes a first rod end portion 60 coupled to the main housing 14 and a second rod end portion 62 coupled to the base 58. According to one embodiment, the main housing 14 may be coupled to the elongate rod 56 via a connector assembly 64 (see FIG. 3) including cooperating first and second connector elements 34, 36. In the exemplary embodiment, the first connector element includes the plug 34 comprised of a tubular sleeve 66 adapted to circumferentially engage the extension arm 12. In particular, the tubular sleeve 66 extends into the neck portion 24 of the main housing 14 and along an outer surface of the arm 12 to capture the arm 12 therein. The arm 12 may be frictionally engaged with the tubular sleeve 66 or an adhesive may also be used to secure the arm 12 to the tubular sleeve 66.

The first connector element 34 further comprises a shaft 68 opposite the tubular sleeve 66, wherein the shaft 68 is configured to be insertable into a complimentary opening formed within the second connector element 36 for connecting the first connector element 34 to the second connector element 36. The shaft 68 may be engaged with the second connector element 36 via a slip-fit engagement, threaded engagement or via mechanical fasteners, such as an adhesive. The first connector element 34 also includes a radially protruding flange 70 positioned between the tubular sleeve 66 and the shaft 68.

The second connector element 36 is a tubular structure having an inner surface defining the opening which is adapted to receive the shaft 68 of the first connector element 34, and an outer surface sized to be substantially complimentary to the inner surface of the elongate rod 56. The second connector element 36 includes an outer circumferential groove 72 (see FIG. 5) formed in the second connector element 36 which is sized to receive a retaining ring 74 which secures the second connector element 36 within the elongate rod 56. Along these lines, the elongate rod 56 may be hollow or include a recess at the first rod end portion 60 sized to receive the second connector element 36. A lip 76 may be formed on the rod 56, wherein the lip 76 is sized and configured to engage with the second connector element 36 when the second connector element 36 is placed in the elongate rod 56. In this respect, the lip 76 may be formed at a depth which is substantially equal to the length of the second connector element 36.

The main housing 14 may be snapped onto the elongate rod 56 by way of the connector assembly 64. In particular, the first connector element 34 may be engaged with the second connector element 36 by inserting the shaft 68 into the opening. Furthermore, the second connector element 36 may be snapped into the elongate rod 56 such that the retaining ring 74 mitigates removal of the second connector element 36 from the elongate rod 56 once the second connector element 36 has been inserted into the rod 56. When the main housing 14 is attached to the elongate rod 56, the main housing 14 is preferably capable of swiveling or rotating relative to the elongate rod 56.

Certain embodiments may allow for easy detachment of the main housing 14 from the elongate rod 56 by either removing the first connector element 34 from the second connector element 36, or by pulling the second connector element 36 out of the elongate rod 56.

The elongate rod 56 may be formed of a plurality of rod segments 78, 80 which may be cooperatively engageable with each other. According to one embodiment, a first rod segment 78 includes a male engagement portion that is cooperatively engageable with a corresponding female engagement portion formed on an adjacent second rod segment 80. The male and female engagement portions may be threadably engageable with each other. It is understood that the male engagement portion may be located on the second rod segment 80 and the female engagement portion may be located on the first rod segment 78 without departing from the spirit and scope of the present invention.

The base 58 is connected to the lower end portion of the elongate rod 56. Preferably, the base 58 is threadably engageable with the elongate rod 56, which would allow a user to simply screw or rotate the rod 56 onto the base 58. It is also contemplated that the rod 56 may be press-fit onto the base 58, such that the engagement between the rod 56 and the base 58 is by way of frictional engagement.

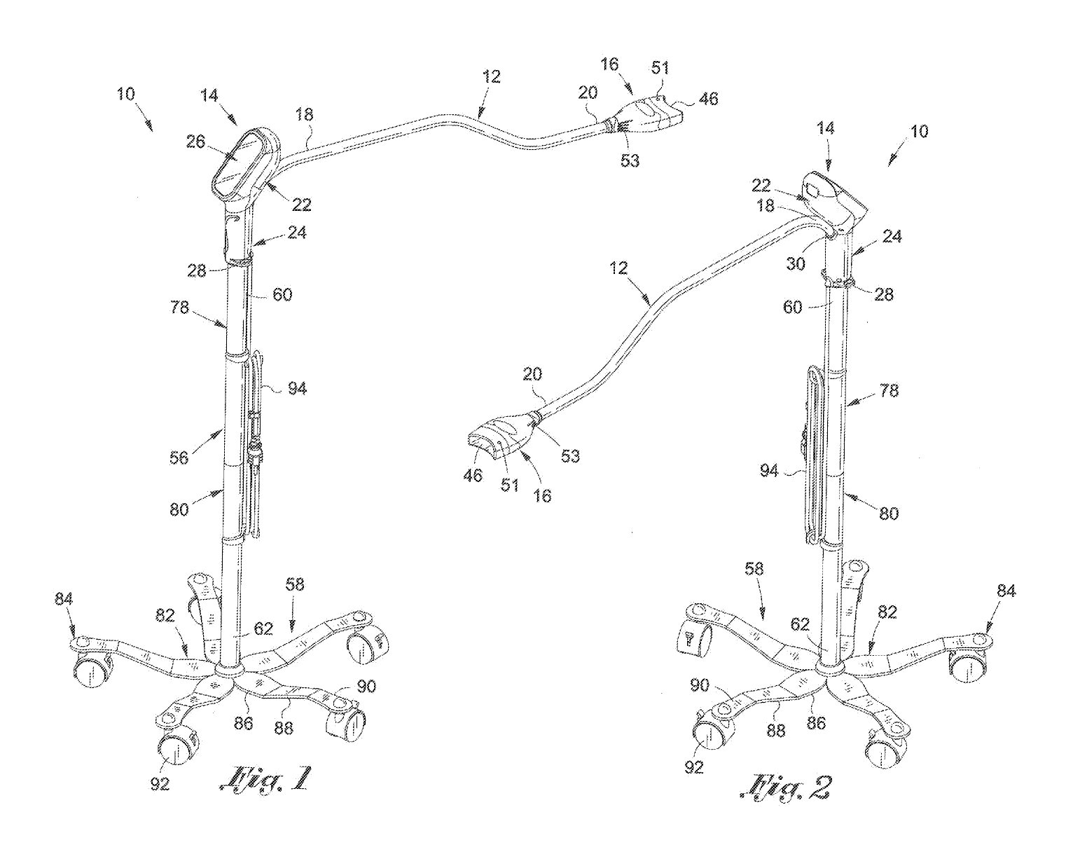

According to one embodiment, the base 58 includes a central region 82 and a peripheral region 84 located radially outward of the central region 82. The central region 82 is preferably recessed relative to the peripheral region 84 to lower the center of gravity of the base 58 to provide enhanced stability. The base 58 illustrated in FIGS. 1-3 includes five arms arranged around a common axis. Each arm is comprised of three sections, including a central section 86, an intermediate section 88, and a peripheral section 90. During use, the central section 86 is lower than the peripheral section 90, while the intermediate section 98 joins the central section 86 to the peripheral section 90. The base 58 may include a plurality of wheels 92 coupled to respective ones of the arms at the peripheral section 90 thereof, wherein the wheels 92 are adapted to elevate the central region 82 of the base 58 off the ground and facilitate movement of the teeth whitening device 10.

Referring now to FIG. 6, there is shown a clamp 100, which may be used as an alternative to the elongate rod 56 and the base 58. In particular, the clamp 100 may be attachable to the main housing 14 for mounting the main housing 14, extension arm 12, and light emitting unit 16 to a table 102, desk, or other similar structure. According to one embodiment, the clamp 100 includes a C-shaped body 104, an adjustable clamping member 106, and an attachment shaft 108. The C-shaped body 104 includes opposed first and second arms 110, 112, wherein the adjustable clamping member 106 is moveably coupled to the second arm 112. The clamping member 106 is moveable toward the first arm 110 to allow the clamp 100 to be secured to the table 102 or similar structure. According to one embodiment, the clamping member 106 includes a threaded shaft 114 threadedly engaged with an opening formed in the second arm 112. A disc 116 is coupled to a first end of the threaded shaft 114 to provide a mechanism by which a user may rotate the shaft 116. An engagement pad 118 is located on an opposing second end of the threaded shaft 114 and is adapted to provide a cushioned interface between the clamp 100 and the table 102 so as to prevent damage to the table 102. To attach the clamp 100 to the table 102, the clamping member 106 is rotated in a first direction to move the engagement pad 118 toward the table 102 to capture the table 102 between the engagement pad 118 and the first arm 110. To detach the clamp 100 from the table 102, the clamping member 106 is rotated in a second direction to move the engagement pad 118 away from the first arm 110.

The attachment shaft 108 is configured similar to the upper end portion 60 of the elongate rod 56 so as to engage with the main housing 14 in a similar manner. In particular, the main housing 14 may be pressed into the attachment shaft 108 to secure the main housing 14 thereto. The main housing 14 may also be capable of swiveling relative to the attachment shaft 108 once engaged therewith.

According to one embodiment, the teeth whitening device 10 includes a user interface 26 for allowing a user or a technician to program or operate the device 10. The user interface 26 may include a time indicator for displaying the amount of time left in the teeth whitening treatment, as well as a time setting button(s) to adjusting the time of the procedure. The user interface 26 may further include a start/pause button, a stop button, and a power button. As used herein, the word “button” is broad enough to encompass a physical button as well as a “virtual” button used on a touch screen display. The user interface 26 may also include a dimmer for controlling the intensity of light emitted by the device. The dimmer may include a button(s), a dial, a slide tab or other dimming mechanisms known in the art

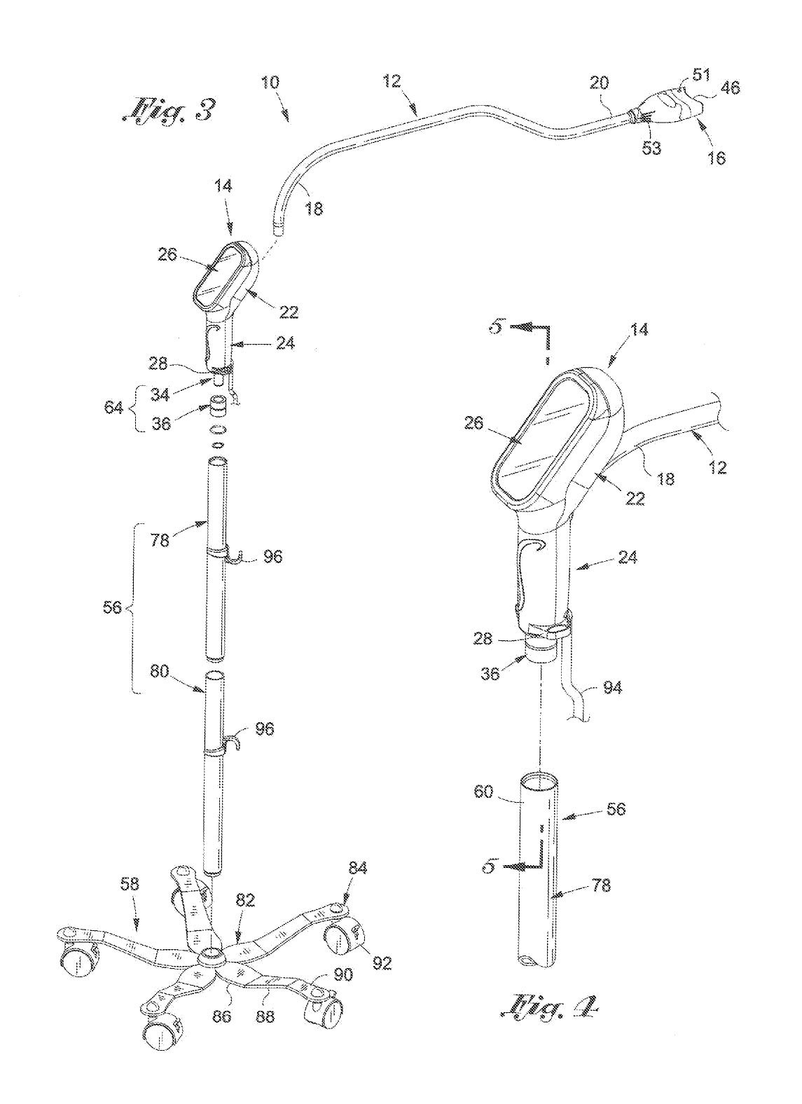

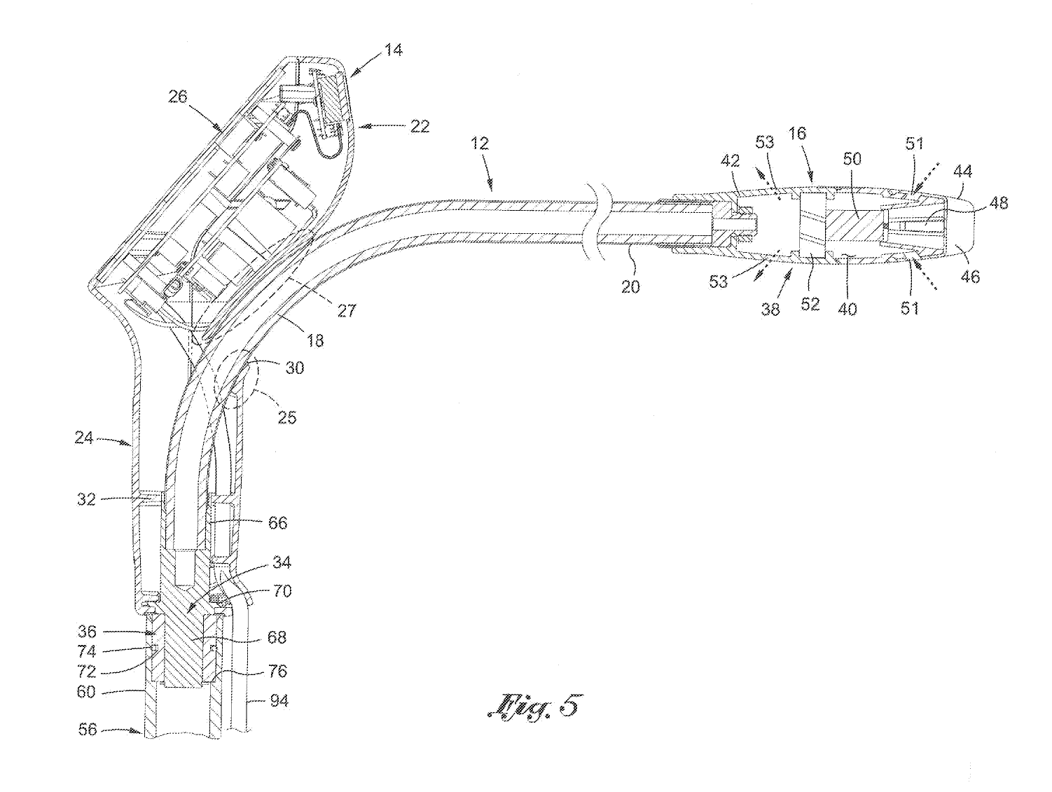

The teeth whitening device 10 includes a power cord 94 for receiving power from an external power source, such as a wall socket or the like. One or more cord holders 96 may be coupled to the elongate rod 56 to neatly stow the cord 94. As shown in FIGS. 1 and 2, the power cord 94 is wrapped around a pair of spaced cord holders 96. Although the exemplary embodiment includes a power cord 94 for receiving external power, it is understood that other embodiments may include an internal power source, such as a battery for supplying power to the electrical components.

One unique aspect of the present invention is the ability of the teeth whitening device 10 to be assembled without any tools (or at least a very minimal amount of tools). As such, when a customer receives the teeth whitening device 10 in a disassembled state, the customer can quickly and easily assemble the teeth whitening device 10 for use. According to one implementation, the teeth whitening device 10 may be sold and packaged in three main subassemblies. The first subassembly includes the main housing 14, the extension arm 12, the light emitting unit 16, and the power cord 94. The second subassembly includes the elongate rod 56, and the third subassembly includes the base 58 and wheels 92. The first step in assembling the device 10 is to construct the elongate rod 56. The elongate rod 56 may be separated into various segments 78, 80, which may be coupled via threaded engagement (e.g., twisting adjacent rod segments 78, 80 together), spring pins and corresponding apertures, etc. The elongate rod 56 may also be a telescoping rod, which may simply require the extension of the rod segments.

Once the rod 56 is assembled, the rod 56 is connected to the base 58. The rod 56 and base 58 may be connected to each other via a threaded engagement, such that the rod 56 may be connected to the base 58 by twisting the rod 56 relative to the base 58.

The assembly of the teeth whitening device 10 further includes securing the first subassembly, i.e., the main housing 14, power cord 94, extension arm 12, and light emitting unit 16, to the elongate rod 56. The first subassembly is preferably sold as an assembled unit and is coupled to the rod 56 by snapping the main housing 14 onto the elongate rod 56.

Once the device 10 is assembled it may be ready for use. Typical use will commence with turning the power switch on, assuming the power cord 94 has been previously plugged into an adjacent wall outlet. With the patient sitting in an upright position, Vitamin E is applied to the patient's lips before the start of the teeth whitening procedure. The patient may also place safety eyewear/goggles on his or her head prior to the procedure beginning. The safety eyewear may be stored on the storage flange 28 extending from the elongate rod 56. The safety eyewear preferably includes red lenses, although it is understood that lenses that are not red may also be used in connection with the teeth whitening procedure.

A tray with whitening gel is inserted into the patient's mouth. The tray is loaded with whitening gel prior to placing the tray in the patient's mouth. The whitening gel may be primarily located in the area of the tray corresponding to the patient's front teeth. The patient relaxes his/her jaw and keeps his/her lips from covering the front of the tray. The teeth whitening device 10 is then positioned adjacent the patient, with the light emitting unit 16 being approximately ⅛″ away from the tray. The light is directed toward the patient's teeth for approximately 20 minutes. After the procedure, the patient rinses his/her mouth 3-4 times with water.

After the procedure is complete, the device 10 is turned off, and the extension arm 12 may be bent downwardly to a stowed configuration, wherein the arm 12 extends substantially next to the rod 56. The power cord 934 may also be unplugged and wrapped around the cord holders 96.

Although the foregoing describes one aspect of the invention which relates to a teeth whitening device 10, it is also contemplated that certain features of the present invention may be incorporated in other devices without departing from the spirit and scope of the present invention. For instance, the unique configuration of the base which lowers the center of gravity may be useful in other applications, such as a base for supporting a pole which holds an IV bag. Furthermore, although the foregoing describes the light emitting unit 16 as emitting light for teeth whitening procedures, it is also contemplated that the light emitting unit may encompass other light functions, such as a reading light or other lighting applications.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A teeth whitening device comprising:
a main housing having a main housing opening disposed about an axis offset from a vertical axis;
an extension arm having a first arm end portion and an opposed second arm end, the extension arm being coupled to the main housing adjacent the first arm and extending through the main housing opening; and
a light emitting unit coupled to the second arm end portion and adapted to emit light within a prescribed wavelength range toward teeth of a user for whitening the teeth;
the extension arm being flexible and capable of assuming a prescribed configuration to enable selective positioning of the light emitting unit relative to the main housing.

2. The teeth whitening device recited in claim 1, wherein the main housing includes a sidewall at least partially defining the main housing opening and adapted to provide support to the extension arm.

3. The teeth whitening device recited in claim 1, further comprising a base coupled to the main housing, the base having a peripheral section and a center section recessed relative to the peripheral section.

4. The teeth whitening device recited in claim 3, wherein the base includes a plurality of wheels mounted to peripheral section.

5. The teeth whitening device recited in claim 3, further comprising an elongate rod having a first rod end portion and an opposing second rod end, the first rod end portion being coupled to the main housing and the second rod end portion being connected to the center section of the base.

6. The teeth whitening device recited in claim 5, wherein the main housing is adapted to be snap engageable with the first rod end.

7. The teeth whitening device recited in claim 1, wherein the light emitting unit includes a light emitting housing, a light, and a heat sink in thermodynamic communication with the light, the light and the heat sink being disposed within the light emitting housing.

8. The teeth whitening device recited in claim 7, further comprising a fan in fluid communication with the heat sink for creating a convective fluid flow over the heat sink.

9. The teeth whitening device recited in claim 8, wherein the fan is located in the light emitting housing.

10. The teeth whitening device recited in claim 1, further comprising a user interface coupled to the main housing.

11. The teeth whitening device recited in claim 10, wherein the user interface includes a touch screen display.

12. A teeth whitening device comprising:
a main housing having a vertical sidewall and a main housing opening;
an extension arm having a first arm end portion and an opposed second arm end, the extension arm being coupled to the main housing adjacent the first arm end portion and extending through the housing opening, the extension arm being at least partially support by the vertical sidewall; and
a light emitting unit coupled to the second arm end portion and adapted to emit light within a prescribed wavelength range toward teeth of a user for whitening the teeth;
the extension arm being flexible and capable of assuming a prescribed configuration to enable selective positioning of the light emitting unit relative to the main housing.

13. The teeth whitening device recited in claim 12, further comprising a base coupled to the main housing, the base having a peripheral section and a center section recessed relative to the peripheral section.

14. The teeth whitening device recited in claim 13, wherein the base includes a plurality of wheels mounted to peripheral section.

15. The teeth whitening device recited in claim 13, further comprising an elongate rod having a first rod end portion and an opposing second rod end, the first rod end portion being coupled to the main housing and the second rod end portion being connected to the center section of the base.

16. The teeth whitening device recited in claim 15, wherein the main housing is adapted to be snap engageable with the first rod end.

17. The teeth whitening device recited in claim 12, wherein the light emitting unit includes a light emitting housing, a light, and a heat sink in thermodynamic communication with the light, the light and the heat sink being disposed within the light emitting housing.

18. The teeth whitening device recited in claim 17, further comprising a fan in fluid communication with the heat sink for creating a convective fluid flow over the heat sink.

19. The teeth whitening device recited in claim 18, wherein the fan is located in the light emitting housing.

20. The teeth whitening device recited in claim 12, further comprising a user interface coupled to the main housing.
